(19) United States
(12) Patent Application Publication
(10) Pub. No.: US 2025/0315275 A1
(43) Pub. Date: Oct. 9, 2025

(54) INTERFACE DISPLAYING METHOD, APPARATUS, DEVICE, AND COMPUTER-READABLE STORAGE MEDIUM

(71) Applicant: GUANGDONG OPPO MOBILE TELECOMMUNICATIONS CORP., LTD., Dongguan, Guangdong (CN)

(72) Inventors: Zhitong HU, Dongguan, Guangdong (CN); Jinding CHEN, Dongguan, Guangdong (CN); Shun WANG, Dongguan, Guangdong (CN); Deyin CHEN, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/873,270

(22) PCT Filed: May 5, 2022
(86) PCT No.: PCT/CN2022/090990

§ 371 Date: Dec. 9, 2024

(30) Foreign Application Priority Data
Jun. 2, 2021 (CN) 202110614417.7

(51) Int. Cl. G06F 9/451

(52) U.S. Cl. CPC G06F 9/451

(57) ABSTRACT

Disclosed in embodiments of the present application are an interface display method and apparatus, a terminal device, and a computer readable storage medium. The method comprises: determining a current running state of the terminal device, the running state comprising any one of a first state in which a first operating system continuously runs in the foreground, a second state in which only a second operating system runs, and a third state in which the first operating system and the second operating system alternately run, and the first state, the second state, and the third state respectively corresponding to different running power consumption and running performance; and drawing an interface according to a display effect corresponding to the current running state, and displaying the interface.

The present application claims the priority of the Chinese patent application No. 202110614417.7, filed on Jun. 2, 2021, in the title of “INTERFACE DISPLAYING METHOD, APPARATUS, DEVICE, AND COMPUTER-READABLE STORAGE MEDIUM”, contents of which are incorporated herein by its entireties.

### TECHNICAL FIELD

Embodiments of the present disclosure relate to the technical field of terminals, and more specifically, to an interface displaying method, an apparatus, a device, and a computer-readable storage medium.

### BACKGROUND

In the art, a terminal device usually supports only one operating system. Take wearable watches as an example, the wearable watches can be categorized into smart watches and smart bracelets, the smart watches are usually installed with a smart operating system that has powerful performance and supports installation and uninstallation of various applications, such as the Android and the IOS, and so on. The smart bracelets are usually installed with an embedded operating system that has a single function and does not support application installation and uninstallation, but has low power consumption.

Currently, a terminal device cannot optimize both power consumption and displaying performance while displaying an interface. Taking smart watches and smart bracelets as an example, the smart watch can display highly-expressive interfaces but has high power consumption. The smart bracelet has low power consumption but displays interfaces having poor expression.

### SUMMARY

The present disclosure provides an interface displaying method, an apparatus, a device, and a computer-readable storage medium, where both power consumption of a terminal device displaying an interface and a displaying effect can be taken into account.

The present disclosure provides an interface displaying method, including:
determining a current operation state of a terminal device, wherein the operation state comprises any one of: a first state in which a first operating system is constantly running in a foreground, a second state in which only a second operating system is running, and a third state in which the terminal device is operating by switching between the first operating system and the second operating system; each of the first state, the second state, and the third state corresponds to a respective operating power consumption different from each other and a respective operating performance different from each other; and
drawing an interface based on a displaying effect corresponding to the current operation state and displaying the drawn interface.

The present disclosure provides an interface displaying apparatus, including:
a state determination module, configured to determine a current operation state of a terminal device, wherein the operation state comprises any one of: a first state in which a first operating system is constantly running in a foreground, a second state in which only a second operating system is running, and a third state in which the terminal device is operating by switching between the first operating system and the second operating system; each of the first state, the second state, and the third state corresponds to a respective operating power consumption different from each other and a respective operating performance different from each other; and
a drawing module, configured to draw an interface based on a displaying effect corresponding to the current operation state and display the drawn interface.

The present disclosure provides a terminal device, including: a memory and a processor. The memory stores a computer program therein, the computer program is configured to cause, when being executed by the processor, the processor to implement the method described in the above.

The present disclosure provides a computer-readable storage medium, storing a computer program. The computer program is configured to cause, when being executed by a processor, the processor to implement the method described in the above.

Details of one or more embodiments of the present disclosure are presented in the accompanying drawings and description below. Other features and technical effects of the present disclosure will be apparent from the specification, the accompanying drawings, and the claims.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is an application scenario of an interface displaying method according to an embodiment of the present disclosure.

FIG. 2 is a flow chart of the interface displaying method according to an embodiment of the present disclosure.

FIG. 3 is a schematic view of a terminal device in various operation states according to an embodiment of the present disclosure.

FIG. 4 is a flow chart of a first operation system drawing and displaying an interface, when the terminal device running the first operation state, according to an embodiment of the present disclosure.

FIG. 5A is a schematic view of a dynamic interface according to an embodiment of the present disclosure.

FIG. 5B is a schematic view of the dynamic interface according to an embodiment of the present disclosure.

FIG. 6 is a flow chart of determining a current operation state of the terminal device according to an embodiment of the present disclosure.

FIG. 7 is a schematic view of the terminal device switching between the first operation system and a second operation system according to an embodiment of the present disclosure.

FIG. 8A is a schematic view of selecting an operating mode according to an embodiment of the present disclosure.

FIG. 8B is a schematic view of an interface in which activating an animation effect is selected according to an embodiment of the present disclosure.

FIG. 9 is a schematic diagram of an interface displaying apparatus according to an embodiment of the present disclosure.

FIG. 10 is a structural schematic diagram of a terminal device according to an embodiment of the present disclosure.

### DETAILED DESCRIPTIONS

The technical solutions in the embodiments of the present disclosure will be described clearly and completely in the following by referring to the accompanying drawings in the embodiments of the present disclosure. Obviously, the described embodiments are only a part of, not all of, the embodiments of the present disclosure. All other embodiments, which are obtained by any ordinary skilled person in the art based on the embodiments in the present disclosure without making creative work, shall fall within the scope of the present disclosure.

It is to be noted that the terms “comprise” and “have” and any variations thereof used in the embodiments and the accompanying drawings of the present disclosure are intended to cover non-exclusive inclusion. For example, a process, a method, a system, a product or an apparatus comprising a series of steps or units is not limited to the listed steps or units, but may further include steps or units that are not listed or are inherently included in the process, the method, the system, the product or the apparatus.

It is understood that the terms “first”, “second”, and so on, used in the present disclosure may describe various elements, but the elements are not limited by these terms. These terms are used only to distinguish a first element from another element. For example, without departing from the scope of the present disclosure, a first operating system may be referred to as a second operating system, and similarly, a second operating system may be referred to as a first operating system. Both the first operating system and the second operating system are operating systems, but the first operating system and the second operating system are not the same operating system.

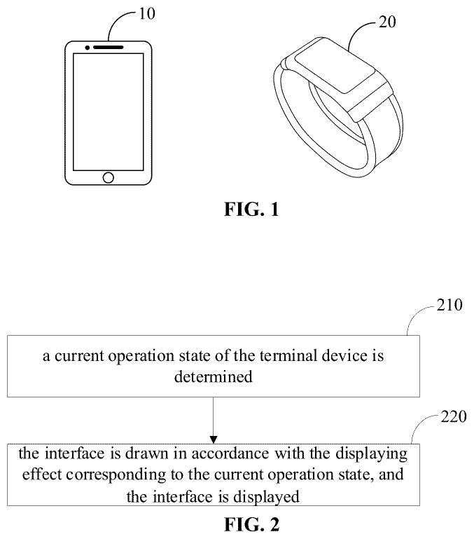

FIG. 1 an application scenario of an interface displaying method according to an embodiment. As shown in FIG. 1, the interface displaying method in the embodiments of the present disclosure may be applied to a terminal device supporting a plurality of operating systems. The terminal device includes, but is not limited to, a smart phone 10, a smart wearable device 20, a tablet computer, a laptop computer, a vehicle-mounted terminal, a personal computer (PC), and the like. At least two operating systems may be installed in the terminal device, for example, the terminal device may be installed with both an embedded operating system (such as a real-time operating system (RTOS) and a smart operating system (such as the IOS system, the Android system, and so on). Alternatively, the terminal device may be installed with a plurality of smart operating systems or a plurality of embedded operating systems. Specific operating systems installed on the terminal device are not limited by the present disclosure.

In some embodiments, a plurality of processors are arranged in the terminal device, or one multi-core processor, such as a dual-core processor, a quad-core processor, and so on, may be arranged in the terminal device. In this way, different operating systems may be run by different processors or by different cores in one processor.

In the present disclosure, the terminal device may determine a current operation state; draw an interface in accordance with a displaying effect corresponding to the current operation state; and display the interface. The operation state of the terminal device may include any one of: a first state in which a first operating system is constantly running in a foreground, a second state in which only a second operating system is running, and a third state in which the terminal device operates by switching between the first operating system and the second operating system.

Each of the first state, the second state, and the third state corresponds to a respective operating power consumption and a respective operating performance. In some embodiments, the first operating system may be the smart operating system having enriched functions and power performance but also having a large power consumption. The second operating system may be the embedded operating system having simpler functions and poorer performance but having a smaller power consumption. The operating power consumption of the first state may be greater than the operating power consumption of the third state. The operating power consumption of the third state may be greater than the operating power consumption of the second state. The operating performance of the first state may be higher than the operating performance of the third state, and the operating performance of the third state may be higher than the operating performance of the second state.

The terminal device may determine a respective interface displaying strategy for each operation state based on the installed dual operating systems and display the interface having a respective displaying effect for each operation state. Since each operation state corresponds to the respective operating power consumption and the respective operating performance, both the power consumption of displaying the interface and the displaying effect of the interface can be optimized. Endurance of the terminal device is improved, and demands of various users for the power consumption or the displaying effect of the interface can be satisfied.

As shown in FIG. 2, in an embodiment, an interface displaying method is provided, which may be performed by the terminal device described above, and the method may include the following blocks.

In a block 210, a current operation state of the terminal device is determined.

In the present embodiment, at least the first operating system and the second operating system are installed in the terminal device. The first operating system and the second operating system are run on different processors or run in different cores of a same processor. The first operating system may be the smart operating system (such as the Android operating system, the IOS, and so on) having enrich functions and powerful performance but having the large power consumption. The second operating system may be the embedded operating system (such as the RTOS, and so on) having simpler functions and poorer performance but the smaller power consumption.

In some embodiments, the first operating system may be run in a large-core processor of the terminal device, and the second operating system may be run in a small-core processor of the terminal device. Processing performance of the large-core processor is better than that of the small-core processor, and power consumption of the large-core processor is greater than that of the small-core processor. The user may switch between operating systems of the terminal device according to practical demands. When the better processing performance is required (such as using various applications, phone calls, internet access, and so on), the terminal device may be switched to the first operating system being run on the large-core processor. When the power consumption of the terminal device needs to be reduced, the terminal device may be switched to the second operating system being run on the small-core processor, such that the endurance of the terminal device is improved.

For the terminal device supporting dual operating systems, various operation states can be defined. Each of the various operation states corresponds to the respective operating power consumption and the respective operating performance. The operating power consumption refers to a battery power consumption caused by the terminal device operating in the respective operation state. The operating performance refers to, for the respective operation state, a utilization rate of the terminal device for various hardware resources (such as a processor, a memory, and so on), a data processing speed, and a type of data that can be processed. The operating power consumption and the operating performance for a same operation state are positively correlated to each other. As the operating performance increases, the operating power consumption increases.

In the embodiments of the present disclosure, the operation state of the terminal device includes the first state in which the first operating system is constantly running in the foreground, the second state in which only the second operating system is running, and the third state in which the terminal device operates by switching between the first operating system and the second operating system. The first operating system running in the foreground means that the first operating system has a control authority over a displaying component of the terminal device and can control the displaying component to display contents. In the first state, the operating system running in the foreground always serves as the first operating system and is not switched to be shut down. In the third state, the operating system running in the foreground may be switched between the first operating system and the second operating system. Each of the first state, the second state, and the third state corresponds to the respective operating power consumption different from each other and the respective operating performance different from each other. The operating power consumption of the first state is greater than that of the third state, the operating power consumption of the third state is greater than that of the second state, the operating performance of the first state is higher than that of the third state, and the operating performance of the third state is higher than that of the second state.

The first state can be understood as a high performance state of the terminal device, where the terminal device operates at high operating performance. The second state can be understood as a long endurance state of the terminal device, where the terminal device is enabled to operate at low power consumption. The third state can be understood as a balanced state, in which both performance and endurance are taken into account and the terminal device switches between the first operating system and the second operating system according to practical operating situations. For example, the terminal device switches to the first operating system when the terminal device is busy; and the terminal device switches to the second operating system when the terminal device is idle.

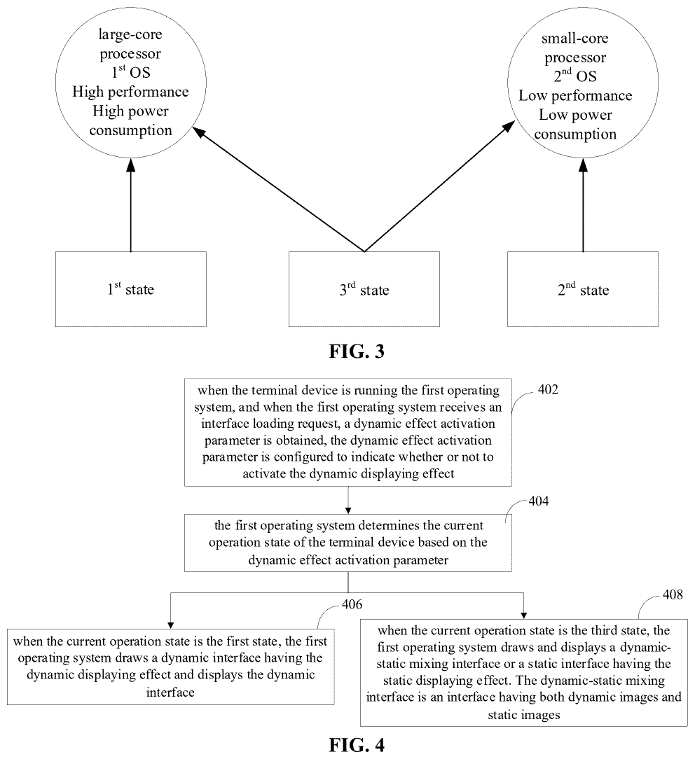

FIG. 3 shows a schematic view of the terminal device in different operation states. As shown in FIG. 3, in the first state, the terminal device runs the first operating system in the large-core processor in the foreground, having high performance and high power consumption. The second operating system may be in a dormant state or operating in a background. Operating in the background may refer to the second operating system not having the control authority over the displaying component of the terminal device. In the second state, the terminal device runs the second operating system in the small-core processor only, having low performance and low power consumption. In the third state, the terminal device may switch between the first operating system and the second operating system according to the practical operating situations.

The terminal device may determine the current operation state, and the current operation state may be any one of the above states.

In a block 220, the interface is drawn in accordance with the displaying effect corresponding to the current operation state, and the interface is displayed.

The interface displayed on the terminal device corresponds to various displaying effects under various operation states. In some embodiments, the displaying effects include, but are not limited to, a dynamic displaying effect, a static displaying effect, and a dynamic-static mixing displaying effect. Drawing and displaying interfaces with different displaying effects have different requirements for the current operating performance of the terminal device and generate different power consumption. For example, the interface of the dynamic displaying effect needs to be drawn by a processor having a powerful data processing capability, drawing the interface of the dynamic displaying effect has high requirements for the operating performance, and displaying the interface of the dynamic displaying effect generates large power consumption. The interface of the static displaying effect needs to be drawn by a processor having a weak data processing capability, drawing the interface of the static displaying effect has reduced requirements for the operating performance, and displaying the interface of the static displaying effect generates reduced power consumption.

Since different operation states correspond to different operating power consumption and different operating performance, the respective displaying effect that matches the corresponding operating power consumption and operating performance is set for each operation state. For example, when the terminal device is in the first state and has the high operating performance, the displaying effect of the interface is set to be the dynamic displaying effect, ensuring that the interface with the dynamic displaying effect is accurately drawn, such that the interface is displayed smoothly and a visual effect is ensured. When the terminal device is in the second state and has the lower operating performance and lower power consumption, the displaying effect of the interface is set to be the static displaying effect, ensuring that the interface is normally displayed of the interface, the power consumption of the terminal device is reduced, and the endurance of the terminal device is improved. When the terminal device is in the third state, the displaying effect of the interface is set to the dynamic-static mixing displaying effect or the static displaying effect, such that the power consumption generated by drawing the interface is reduced, and the visual effect is takes into account to a certain extent.

In the present embodiment, the current operation state of the terminal device is determined, and the interface is drawn and displayed in accordance with the displaying effect corresponding to the current operation state. The current operation state includes any one of: the first state in which the first operating system is constantly running in the foreground, the second state in which only the second operating system is running, and the third state in which the terminal device is operating by switching between the first operating system and the second operating system. The interfaces with different displaying effects are displayed for different operation states of the terminal device. In this way, the displaying effects of the interface are enriched and different demands of the user for interface displaying on the terminal device in different operation states are satisfied. Since the first state, the second state, and the third state correspond to different operating power consumption and different operating performance, the power consumption and displaying effect of displaying the interface can be taken into account at the same time, and the endurance of the terminal device can be improved.

As shown in FIG. 4, in some embodiments, for the interface displaying method of the present disclosure, when the terminal device is running the first operating system, the first operating system may perform following blocks to draw and display the interface.

In a block 402, when the terminal device is running the first operating system, and when the first operating system receives an interface loading request, a dynamic effect activation parameter is obtained, the dynamic effect activation parameter is configured to indicate whether or not to activate the dynamic displaying effect.

When the terminal device is running the first operating system, the corresponding operation state may be the first state or the third state. Since the first operating system is run on the large-core processor having the high performance and the high power consumption, different displaying effects of the interface are set for the first state and the third state, such that different demands of the user for the displaying effect and the endurance can be both met.

In some embodiments, the terminal device may be set with a dynamic effect switch. The user may trigger the dynamic effect switch to activate or deactivate the dynamic displaying effect. When the dynamic displaying effect is activated, the terminal device may draw the interface having enriched dynamic displaying effect. The interface having enriched dynamic displaying effect includes, but is not limited to, a desktop displaying interface and an application displaying interface having the dynamic displaying effect. For example, the interface includes a 2-dimensional (2D) animation interface, a 3-dimensional (3D) animation interface, and a video interface. When the dynamic displaying effect is deactivated, the terminal device draw only a static interface having the static displaying effect or an interface having a small amount of dynamic displaying effects. The user may determine whether to activate the dynamic displaying effect according to actual demands, such that various demands are satisfied, and user viscosity is improved.

The terminal device may set a dynamic effect activation parameter. The dynamic effect activation parameter is configured to record whether the dynamic effect switch is activated or deactivated. When the terminal device detects that the user performs a turn-on operation/turn-off operation on the dynamic effect switch, the terminal device may update the dynamic effect activation parameter. The turn-on operation and the turn-off operation correspond to different dynamic effect activation parameters.

In a block 404, the first operating system determines the current operation state of the terminal device based on the dynamic effect activation parameter.

When the first operating system receives the interface loading request, the first operating system reads a current dynamic effect activation parameter and determines whether the dynamic displaying effect is currently activated according to the read dynamic effect activation parameter. In some embodiments, the dynamic effect activation parameter includes a first parameter and a second parameter. The first parameter indicates that the dynamic displaying effect is activated, and the second parameter indicates that the dynamic displaying effect is deactivated. The first parameter and the second parameter may be set according to actual demands. Each of the first parameter and the second parameter may be a respective character different from each other. The character includes, but is not limited to, a number, a letter, a symbol, and the like. For example, the first parameter may be a number “1”, and the second parameter may be a number “0”. Alternatively, the first parameter may be a letter “A”, and the second parameter may be a letter “B”. Settings of the character is not limited herein.

When the dynamic effect activation parameter read by the first operating system is the first parameter, it means that the dynamic effect activation parameter indicates that the dynamic displaying effect is activated, and the terminal device needs to run in the high performance state in order to support drawing and displaying of the interface with the dynamic displaying effect. Therefore, the first operating system determines that the current operation state of the terminal device is the first state.

When the dynamic effect activation parameter read by the first operating system is the second parameter, it means that the dynamic effect activation parameter indicates that the dynamic displaying effect is deactivated, and the terminal device does not need to run in the high performance state to achieve drawing and displaying the interface. Therefore, the first operating system determines that the current operation state of the terminal device is the third state.

In a block 406, when the current operation state is the first state, the first operating system draws a dynamic interface having the dynamic displaying effect and displays the dynamic interface.

In some embodiments, the interface loading request may carry an interface identity of a to-be-loaded interface. The first operating system may obtain respective interface data of the to-be-loaded interface for each displaying effect based on the interface identity. The interface data include, but not limited to, texture data, image elements, color data, and so on. The first operating system obtains the interface data corresponding to the displaying effect of the current operation state of the terminal device according to the current operation state and draws the interface with the displaying effect according to the interface data.

When the current operation state of the terminal device is the first state and the dynamic displaying effect is activated, the first operating system draws the dynamic interface with the dynamic displaying effect. The dynamic interface may include, but not limited to, the 2D animation interface, the 3D animation interface and the video interface.

In some embodiments, one dynamic interface includes a plurality of different displaying frames. Each displaying frame corresponds to one dynamically changing image. The interface data of the dynamic interface include texture data, image elements, color data, and the like of each displaying frame and a timestamp corresponding to each displaying frame. The first operating system draws each displaying frame in sequence according to the interface data of the dynamic interface in accordance with an order of timestamps of the plurality of different displaying frames; and takes the drawn displaying frames to refresh a display screen to form the dynamic interface with the dynamic displaying effect.

In some embodiments, the first operating system obtains a current remaining power level of the terminal device and determines a refreshing frame rate of the dynamic interface based on the remaining power level. The refreshing frame rate refers to a rate of refreshing an image displayed on the screen per unit of time. The remaining power level may be positively correlated with the refreshing frame rate. The remaining power level being high indicates that a power level of the terminal device is sufficient, and the refreshing frame rate of the dynamic interface is high. In this way, the displaying effect of the dynamic interface is improved. The remaining power level being less indicates that the power level of the terminal device is insufficient, and the refreshing frame rate of the dynamic interface can be reduced. In this way, power consumption caused by drawing and displaying the dynamic interface can be reduced, and endurance of the terminal device is improved.

In some embodiments, the first operating system may be directly set with a smaller refreshing frame rate and draws and displays the dynamic interface according to the smaller refreshing frame rate. In this way, the power consumption caused by the dynamic interface is reduced, and the endurance of the terminal device is improved.

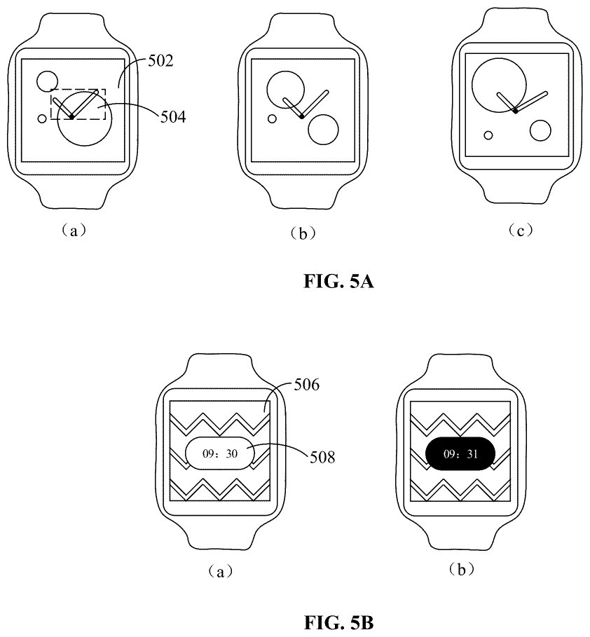

FIG. 5A shows a schematic diagram of the dynamic interface in an embodiment. As shown in FIG. 5A, in an example, the terminal device is the smart watch, and the interface is a watch face of the smart watch. When the smart watch is running the first operating system and the dynamic effect is activated, the first operating system draws a dynamic watch face. The dynamic watch face includes a background image 502 having the dynamic displaying effect and an information displaying pattern 504 having the dynamic displaying effect. The information displaying pattern 504 includes one or more displaying patterns of information such as time, the power level, a signal, and so on. The information displaying pattern in FIG. 5A is a pointer for indicating the time. Each of (a), (b), and (c) in FIG. 5A respectively corresponds to a dynamic watch face interface at different time points. As can be intuitively seen from (a), (b), and (c) that the background image 502 and the information displaying pattern 504 can dynamically change.

In an implementation, the first operating system may invoke a drawing interface in the first operating system and send a drawing instruction to an image processor through the drawing interface. The image processor may draw the dynamic interface according to the drawing instruction and sends the display data obtained from the drawing to the screen to be displayed.

In the present embodiment, when the terminal device is in the first state, the first operating system may draw the dynamic interface with the dynamic displaying effect, such that the displaying effect of the interface is enriched, the visual effect of the interface is ensured, and demands of the user for the displaying effect of the interface are met.

In a block 408, when the current operation state is the third state, the first operating system draws and displays a dynamic-static mixing interface or a static interface having the static displaying effect. The dynamic-static mixing interface is an interface having both dynamic images and static images.

When the current operation state of the terminal device is the third state and the dynamic displaying effect is deactivated, the first operating system draws the dynamic-static mixing interface or the static interface with the static displaying effect. A dynamic displaying effect of the dynamic-static mixing interface is less than the dynamic displaying effect of the dynamic interface drawn by the first operating system when the terminal device is in the first state. For a same interface, when the terminal device is in the first state, the first operating system may draw the dynamic interface with a complete dynamic displaying effect; and when the terminal device is in the third state, the dynamic-static mixing interface drawn by the first operating system may only retain part of the dynamic displaying effect, such that power consumption caused by drawing and displaying the interface is reduced.

FIG. 5B shows a schematic view of the dynamic interface in an embodiment. As shown in FIG. 5B, in an example, the terminal device is the smart watch, and the interface is the watch face interface of the smart watch. When the smart watch is running the first operating system and the dynamic displaying effect is deactivated, the first operating system draws a dynamic-static mixing watch face interface. The dynamic-static mixing watch face interface includes a background image 506 with the static displaying effect and an information displaying pattern 508 with the dynamic displaying effect. The information displaying pattern 508 includes one or more displaying patterns of information such as time, the power level, and the signal. Each of (a) and (b) in FIG. 5B corresponds to the respective dynamic-static mixing watch face interface at different time points. As can be intuitively seen from (a) and (b) that the background image 506 is static and does not change, whereas the information displaying pattern 508 dynamically changes.

In some embodiments, the first operating system drawing the dynamic-static mixing interface, includes the following. The first operating system draws a static background image, and draws the information displaying pattern with the dynamic displaying effect on the static background image. Richness of dynamic changes corresponding to the information displaying pattern is in a negative correlation with the remaining power level of the terminal device.

In some embodiments, the richness of dynamic changes refers to a frequency of re-drawing and displaying the information displaying pattern on the dynamic-static mixing interface. A greater richness of dynamic changes indicates that the frequency of the first operating system re-drawing and displaying the information displaying pattern on the dynamic-static mixing interface is higher, and the dynamic-static mixing interface has a better the visual effect. A lower richness of dynamic changes indicates that the frequency of the first operating system re-drawing and displaying the information displaying pattern on the dynamic-static mixing interface is lower, and power consumption generated by the dynamic-static mixing interface is smaller.

Taking FIG. 5B as an example, the richness of dynamic changes of the information displaying pattern 508 in FIG. 5B refers to a frequency of the information displaying pattern 508 changing between black characters on a white background and white characters on a black background. As the remaining power level of the terminal device is smaller, the frequency of the information displaying pattern 508 changing between black characters on the white background and white characters on the black background is reduced, such that a refreshing rate the interface is reduced, the power consumption may be reduced, and the endurance of the terminal device may be improved.

In some embodiments, the richness of dynamic changes may alternatively refer to the number of information displaying patterns that have dynamic changes in the dynamic-static mixing interface. The dynamic-static mixing interface may contain a plurality of information displaying patterns representing different information, such as an information displaying pattern representing signal strength, an information displaying pattern representing the time, an information displaying pattern representing the power level, an information displaying pattern representing weather, and so on. The greater richness of dynamic changes indicates that the number of information displaying patterns having dynamic changes in the dynamic-static mixing interface is larger, and the interface has a better visual effect. A lower richness of dynamic changes indicates that the number of information displaying patterns having dynamic changes in the dynamic-static mixing interface is smaller, and the power consumption generated by the interface is lower.

The first operating system draws and displays the dynamic-static mixing interface when the terminal device is in the third state, such that the visual effect of the interface is ensured, power consumption of the terminal device is reduced, and endurance of the terminal device is improved. In addition, a proper interface displaying strategy can be determined in combination with the remaining power level of the terminal device, such that both the displaying effect and the endurance are taken into account

In some embodiments, when the current operation state of the terminal device is the third state, the dynamic displaying effect is deactivated, and the first operating system may directly draw the static interface. The static interface is an interface that does not have any dynamic change. The static interface is refreshed only when information displayed in the interface changes. Therefore, the power consumption of the static interface is the lowest, and the endurance of the terminal device can be improved.

In some embodiments, when the terminal device is running the second operating system, the current operation state of the terminal device is the second state or the third state. In this case, the second operating system draws the static interface having the static displaying effect and displays the static interface.

When the terminal device is running the second operating system, since the second operating system is run by the small-core processor with the low performance and the low power consumption, the second operating system always draws the static interface with the static displaying effect and displays the static interface regardless of whether the terminal device is currently in the second state or the third state. In this way, the displayed interface is compatible with the second operating system, and a situation in which the interface cannot be displayed properly or the power consumption is excessively large is avoided.

In an embodiment, the second operating system may invoke the drawing interface in the second operating system and sends the drawing instruction to the image processor through the drawing interface. The image processor may draw the static interface according to the drawing instruction and send the display data obtained from the drawing to the screen to be displayed.

In the present embodiment, the proper interface displaying strategy can be provided based on the dual operating systems installed in the terminal device. Interfaces with different displaying effects are displayed corresponding to different operation states of the terminal device. In this way, both the power consumption of displaying the interface and the displaying effect of the interface are taken into account. The endurance of the terminal device is improved, and different demands of the user for interface displaying are met.

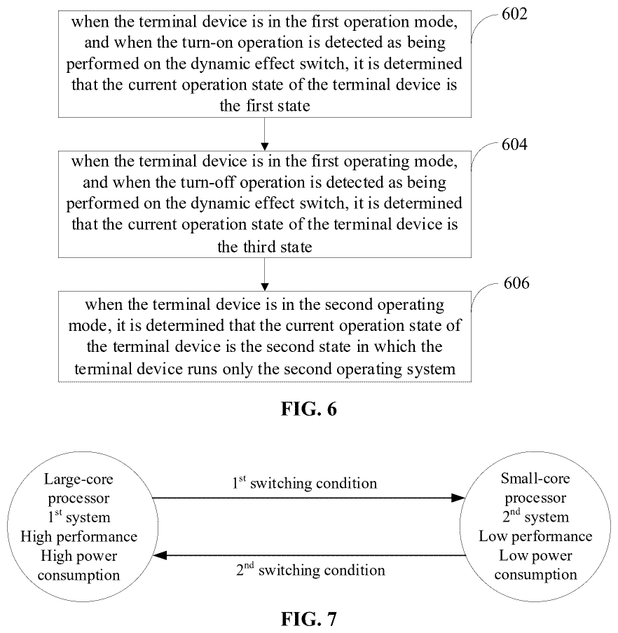

As shown in FIG. 6, in an embodiment, the block of determining the current operation state of the terminal device may include following blocks.

In a block 602, when the terminal device is in the first operation mode, and when the turn-on operation is detected as being performed on the dynamic effect switch, it is determined that the current operation state of the terminal device is the first state.

In an embodiment, the terminal device may be configured with a first operating mode and a second operating mode to be selected by the user. The first operating mode may be an operating mode in which the terminal device can switch between the first operating system and the second operating system. The second operating mode may be an operating mode in which the terminal device can run only the second operating system. The user may select the first operating mode or the second operating mode according to actual demands

The terminal device may further be configured with the dynamic effect switch for the user to determine whether or not to turn on the dynamic displaying effect. In some embodiments, since the second operating mode is the operating mode in which the terminal device can run only the second operating system, and the second operating system is run by the small-core processor that has the lower performance and the lower power consumption, the second operating system cannot support drawing and displaying the interface with the dynamic displaying effect. Therefore, the dynamic effect switch may be turned on or turned off by the user only when the user selects the first operating mode, ensuring the interface to be normally drawn and displayed.

When the terminal device detects that the user performs a first selection operation on the first operating mode, the terminal device may be in the first operating mode. When the terminal device detects the turn-on operation performed by the user on the dynamic effect switch in the first operating mode, it means that the user needs the terminal device to turn on the dynamic displaying effect. The terminal device needs to run the first operating system having the high performance in order to support drawing and displaying the dynamic interface. Therefore, it is determined that the current operation state of the terminal device is the first state in which the first operating system is constantly running in the foreground. The terminal device may run the first operating system. Since the dynamic effect switch is turned on, when the first operating system receives the interface loading request, the first operating system may obtain the dynamic effect activation parameter configured to indicate the dynamic displaying effect being activated. The first operating system may draw and display the dynamic interface with the dynamic displaying effect.

In a block 604, when the terminal device is in the first operating mode, and when the turn-off operation is detected as being performed on the dynamic effect switch, it is determined that the current operation state of the terminal device is the third state.

When the terminal device is in the first operating mode, and when the turn-off operation is detected as being performed by the user on the dynamic effect switch, it means that the user needs the terminal device to deactivate the dynamic displaying effect, and the interface can be drawn and displayed without the high-performance processor. Therefore, it is determined that the current operation state of the terminal device is the third state capable in which the terminal device runs by switching between the first operating system and the second operating system.

In the third state, the interface can be drawn and displayed by the operating system currently running on the terminal device. When the terminal device is currently running the first operating system, since the dynamic effect switch is turned off, the dynamic effect activation parameter configured to indicate the dynamic displaying effect being deactivated may be obtained when the first operating system receives the interface loading request. The first operating system may draw and display the dynamic-static mixing interface or the static interface. When the terminal device is currently running the second operating system, the second operating system may draw and display the static interface.

In some embodiments, the current operation state of the terminal device is the third state, and the terminal device is running the first operating system. When a first switching condition is satisfied, the terminal device is switched to run the second operating system. When the terminal device is running n the second operating system, and when a second switching condition is satisfied, the terminal device is switched to run the first operating system.

In some embodiments, the first switching condition may be distinguished from the second switching condition, and the first switching condition and the second switching condition may be set according to actual demands. FIG. 7 shows a schematic view of the terminal device switching between the first operating system and the second operating system in an embodiment. As shown in FIG. 7, when the terminal device runs the first operating system on the large-core processor, and when the first switching condition is triggered, the second operating system on the small-core processor is switched to run. In this way, the power consumption of the terminal device can be reduced. The first operating system on the large-core processor may enter a dormant state. The dormant state can refer to a state in which the large-core processor is cut off from a power source. When the terminal device runs the second operating system on the small-core processor, and when the second switching condition is triggered, the first operating system on the large-core processor may be awakened, and the terminal device is switched to run the first operating system on the large-core processor. In this way, data processing or operations requiring high performance may be performed, and the second operating system on the small-core processor may enter the dormant state, and that is, the small-core processor is cut off from the power source.

In an embodiment, the first switching condition may be a condition for determining that the terminal device needs to enter a low power consumption and/or low performance state. The first switching condition may include, but is not limited to, one or more of: the terminal device being in a screen-off state for a first time length, the remaining power level of the terminal device being lower than a power threshold, detecting a switching operation of switching from the first operating system to the second operating system. The terminal device being in the screen-off state for the first time length may indicate that the terminal device is in an idle state, and the second operating system with the low power consumption and the low performance may be run. The remaining power level of the terminal device is lower than the power threshold may indicate that the power level of the terminal device is insufficient, and the second operating system with the low power consumption and the low performance may be run. The terminal device may also be configured with a key for switching between the first operating system and the second operating system. The key may be a physical key or a software button. The user may proactively trigger the key for switching from the first operating system to the second operating system to achieve the switching operation of switching from the first operating system to the second operating system.

In an embodiment, the second switching condition may be a condition for determining that the terminal device needs to enter a high performance state. The second switching condition may include, but is not limited to, one or more of: receiving a trigger operation for entering a target application, receiving a display request that displays a list of applications, detecting a switching operation that switches from the second operating system to the first operating system. The target application may refer to an application installed in the first operating system or an application that can be run by the first operating system invoking hardware resources, such as a communication application, a socializing application, a video application, and the like. The list of applications may refer to an application list containing all applications installed in the terminal device. The user may also proactively trigger a key for switching from the second operating system to the first operating system to achieve the switching operation of switching from the second operating system to the first operating system.

In the present embodiment, when the terminal device is in the third state, the terminal device may intelligently switch between the first operating system and the second operating system according to actual operating. In this way, both operating performance and power consumption are taken into account, intelligence of the terminal device is improved, and different demands of the user are met.

In some embodiments, when the current operation state of the terminal device is the third state, the operating system currently being run by the terminal device may draw and display the static interface. When the terminal device switches from the first operating system to the second operating system or switches from the second operating system to the first operating system, the operating system after the switching may draw and display the static interface. However, the displayed static interface is not changed in the visual effect, such that switching between the two operating systems cannot be sensed, such that an interface lag or other undesirable situations during operating system switching can be avoided.

In a block 606, when the terminal device is in the second operating mode, it is determined that the current operation state of the terminal device is the second state in which the terminal device runs only the second operating system.

When the terminal device detects a second selection operation performed on the second operating mode, it is indicated that the terminal device can run only the small-core processor having the low power consumption and the low performance. When the terminal device is in the second operating mode, it is determined that the current operation state of the terminal device is the second state in which the terminal device runs only the second operating system. The terminal device may run the second operating system, and the second operating system draws and displays the static interface.

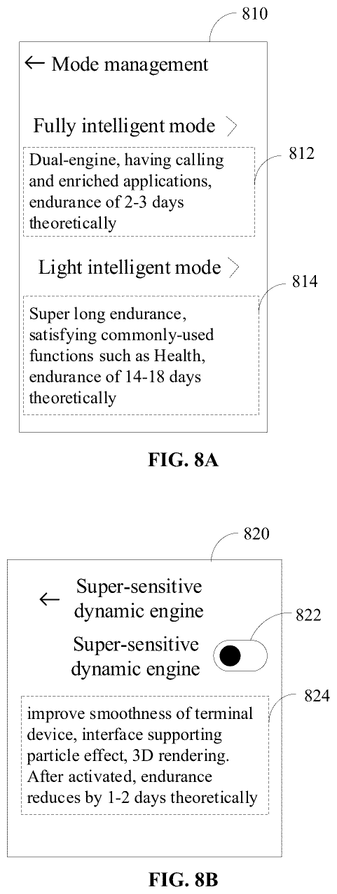

Exemplarily, selecting the operating mode and activating the dynamic displaying effect in the above embodiments are illustrated by referring to FIG. 8A and FIG. 8B. FIG. 8A shows a schematic view of an interface for selecting the operating mode in an embodiment. FIG. 8B shows a schematic view of an interface for selecting to activate the dynamic displaying effect in an embodiment. As shown in FIG. 8A, the terminal device is configured with a mode management interface 810. The mode management interface 810 provides two operating modes to be selected by the user, and the two operating modes are a fully intelligent mode and a light intelligent mode. The fully intelligent mode may be an operating mode in which the terminal device may switch between the first operating system and the second operating system, i.e., the first operating mode described above. The light intelligent mode may be an operating mode in which the terminal device runs only the second operating system, i.e., the second operating mode described above. The mode management interface 810 also displays descriptive information corresponding to each of the two operating modes, such as descriptive information 812 corresponding to the fully intelligent mode and descriptive information 814 corresponding to the light intelligent mode. The descriptive information may include description of characteristics of the operating mode and an approximate endurance time length of the operating mode. In this way, the user is facilitated to understand the two operating modes and to perform selections according to the actual demands.

As shown in FIG. 8B, the terminal device may be provided with a super-sensitive dynamic engine interface 820. The super-sensitive dynamic engine interface 820 may be interpreted as the dynamic effect switch as described above. A switch button 822 may be provided in the super-sensitive dynamic engine interface 820. The user may trigger the switch button 822 according to the actual demand to turn on or turn off the super-sensitive dynamic engine. When the super-sensitive dynamic engine is turned off, the dynamic displaying effect is deactivated. When the super-sensitive dynamic engine is turned on, the dynamic displaying effect is activated. The super-sensitive dynamic engine interface 820 may further display descriptive information 824 corresponding to the super-sensitive dynamic engine. The descriptive information 824 may include a function of the super-sensitive dynamic engine, an effect on the endurance of the terminal device, and the like.

Further, only when the fully intelligent mode is selected in the mode management interface 810, the user may select whether or not to turn on the dynamic displaying effect in the super-sensitive dynamic engine interface 820. When the super-sensitive dynamic engine is turned off, it is determined that the operation state of the terminal device is the third state. When the super-sensitive dynamic engine is turned on, it is determined that the operation state of the terminal device is the first state. When the user selects the light intelligent mode in the mode management interface 810, it is determined that the operation state of the terminal device is the second state.

It is to be noted that FIGS. 8A and 8B are only used to illustrate the embodiments of the present disclosure, and are not used to limit the first operating mode, the second operating mode, and the dynamic effect switch in the embodiments of the present disclosure. The first operating mode, the second operating mode, and the dynamic effect switch may be provided with other names and descriptive information, and a developer of the terminal device may redefine operating modes and the dynamic effect switch in accordance with actual product requirements, which will not be limited herein.

In the present embodiment, the operation state of the terminal device can be switched by arranging the two operating modes and the dynamic effect switch. The user may perform selection according to actual demands, and the operation is simple, various demands of the user can be met. Moreover, the terminal device may draw and display the interface according to different displaying effects under different operation states, such that drawing and displaying of the interface match the corresponding operation state and characteristics of the running operating system. Both the displaying effect of the interface and the power consumption are taken into account, and the endurance of the terminal device is improved.

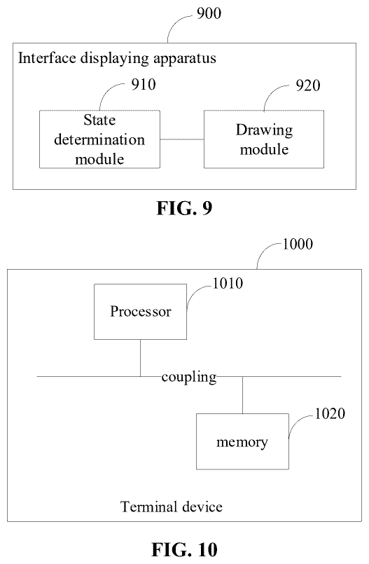

As shown in FIG. 9, in an embodiment, an interface displaying apparatus 900 is provided and arranged in the terminal device described above, and the interface displaying apparatus 900 may include a state determination module 910 and a drawing module 920.

The state determination module 910 is configured to determine the current operation state of the terminal device. The operation state includes any one of: the first state in which the first operating system is constantly running in the foreground, the second state in which only the second operating system is running, and the third state in which the terminal device is operating by switching between the first operating system and the second operating system. Each of the first state, the second state, and the third state corresponds to the respective operating power consumption different from each other and the respective operating performance different from each other.

The drawing module 920 is configured to draw the interface based on the displaying effect corresponding to the current operation state and display the drawn interface.

In the present embodiment, the current operation state of the terminal device is determined, and the interface is drawn and displayed according to the displaying effect corresponding to the current operation state. The operation state includes any one of: the first state in which the first operating system is constantly running in the foreground, the second state in which only the second operating system is running, and the third state in which the terminal device operates by switching between the first operating system and the second operating system. The interface with different displaying effects is displayed for different operation states of the terminal device. The displaying effects of the interface are enriched, and demands of the user for displaying the interface of the terminal device in different operation states are met. Since the first state, the second state, and the third state correspond to different operating power consumption and different operating performance, the power consumption and the displaying effect of the interface can be taken into account at the same time, and the endurance of the terminal device can be improved.

In an embodiment, when the terminal device is running the first operating system, the drawing module 920 is further configured to: draw, by the first operating system, the dynamic interface with the dynamic displaying effect and display the dynamic interface in response to the current operation state being the first state; draw, by the first operating system, the dynamic-static mixing interface or the static interface with the static displaying effect and display the dynamic-static mixing interface or the static interface in response to the current operation state being the third state. The dynamic-static mixing interface is the interface having both dynamic images and static images.

In an embodiment, the above-described interface displaying apparatus 900 includes, in addition to the state determination module 910 and the drawing module 920, a parameter obtaining module.

When the terminal device is running the first operating system, the parameter obtaining module is configured to obtain the dynamic effect activation parameter in response to the first operating system receiving the interface loading request. The dynamic effect activation parameter is configured to indicate whether or not to turn on the dynamic displaying effect.

The state determination module 910 is further configured to determine, by the first operating system, the current operation state of the terminal device based on the dynamic effect activation parameter.

In an embodiment, the state determination module 910 is further configured to: determine, by the first operating system, that the current operation state of the terminal device is the first state in response to the dynamic effect activation parameter indicating that the dynamic displaying effect is turned on; and determine, by the first operating system, that the current operation state of the terminal device is the third state in response to the dynamic effect activation parameter indicating that the dynamic displaying effect is turned off.

In an embodiment, the drawing module 920 is further configured to draw, by the first operating system, the static background image and draw the information displaying pattern with the dynamic displaying effect on the static background image. Richness of dynamic changes corresponding to the information displaying pattern is in a negative correlation with the remaining power level of the terminal device.

In an embodiment, when the terminal device is running the second operating system, the drawing module 920 is further configured to draw, by the second operating system, the static interface having the static displaying effect and display the static interface in response to the current operation state being the second state or the third state.

In the present embodiment, the proper interface displaying strategy may be provided based on the dual operating systems installed in the terminal device. Interfaces with different displaying effects can be displayed for different operation states of the terminal device. In this way, the displayed interface matches the operation state, both the power consumption and the displaying effect of the interface are considered, the endurance of the terminal device is improved, and different demands of the user for displaying the interface are met.

In an embodiment, when the terminal device is in the first operating mode, the state determination module 910 is further configured to determine that the current operation state of the terminal device is the first state in response to detecting the turn-on operation performed on the dynamic effect switch. When the terminal device is in the first operating mode, the state determination module 910 is further configured to determine that the current operation state of the terminal device is the third state in which the terminal device is operating by switching between the first operating system and the second operating system in response to detecting the turn-off operation performed on the dynamic effect switch. When the terminal device is in the second operating mode, the state determination module 910 is further configured to determine that the current operation state of the terminal device is the second state in which the terminal device runs only the second operating system.

The first operating mode is the operating mode in which the terminal device switches between the first operating system and the second operating system, and the second operating mode is the operating mode in which the terminal device runs only the second operating system.

In an embodiment, the interface displaying apparatus 900 includes a system switching module, in addition to the state determination module 910, the drawing module 920, and the parameter obtaining module.

When the current operation state is the third state and the terminal device is running the first operating system, the system switching module is configured to switch to the second operating system in response to the first switching condition being satisfied. When the terminal device is running the second operating system, the system switching module is configured to switch to the first operating system in response to the second switching condition being satisfied. The first switching condition is different from the second switching condition.

In an embodiment, the first switching condition includes one or more of: the terminal device staying in the screen-off state for the first time length, the remaining power level of the terminal device being lower than the power threshold, and detecting the switching operation of switching from the first operating system to the second operating system.

In an embodiment, the second switching condition includes one or more of: receiving the trigger operation that triggers entry the target application, receiving the displaying request for displaying the list of applications, and detecting the switching operation of switching from the second operating system to the first operating system.

In the present embodiment, the operation state of the terminal device can be switched based on the two operating modes and the dynamic effect switch. The user can perform selection according to the actual demands, and operation is simple, different demands of the user can be met. Moreover, the terminal device may draw and display the interface according to different displaying effects under different operation states, such that the interface can be drawn and displayed to match the corresponding operation state and the characteristics of the operating system. Both the displaying effect of the interface and the power consumption are taken into account, and the endurance of the terminal device is improved.

FIG. 10 shows a block diagram of the structure of the terminal device in an embodiment. As shown in FIG. 10, the terminal device 1000 may include one or more of: a processor 1010, a memory 1020 connected to the processor 1010. The memory 1020 may store one or more computer programs, and the one or more computer programs may be configured to implement, when being executed by the one or more processors 1010, the method as described in the above embodiments.

The processor 1010 may include one or more processing cores. The processor 1010 uses various interfaces and lines to connect various components within the terminal device 1000 to perform various functions and to process data of the terminal device 1000 by running or executing instructions, programs, code sets, or instruction sets stored in the memory 1020 and by invoking data stored in the memory 1020. In some embodiments, the processor 1010 may be configured in a hardware form of at least one of: a digital signal processing (DSP), a field-programmable gate array (FPGA), a programmable logic array (PLA). The processor 1010 may integrate one or more of: a central processing unit (CPU), a graphic processing unit (GPU), and a modem. The CPU substantially processes operating systems, user interfaces and application programs, and so on. The GPU is configured to render and draw displaying contents. The modem is configured to perform wireless communication. It is understood that the modem may alternatively not be integrated into the processor 1010 and be configured as a communication chip alone.

The memory 1020 may include a random access memory (RAM) or a read-only memory (ROM). The memory 1020 may be used to store instructions, programs, codes, code sets, or instruction sets. The memory 1020 may include a storage program area and a storage data area. The storage program area may store instructions for implementing operating systems, instructions for implementing at least one functions (such as a touch function, a sound playing function, an image displaying function, and so on), instructions for implementing each of the above-described method embodiments. The storage data area may further store data created when the terminal device 1000 is in use.

It is understood that the terminal device 1000 may include more or fewer structural components than those in the above-described structural block diagram, including a power module, a physical button, a Wireless Fidelity (Wi-Fi) module, a speaker, a Bluetooth module, a sensor, and so on, which are not limited herein.

Embodiments of the present disclosure further provide a computer-readable storage medium storing a computer program. The computer program, when being executed by a processor, implements the method as described in the above embodiments.

Embodiments of the present disclosure provide a computer program product including a non-transitory computer-readable storage medium storing a computer program, and the computer program can be executable by a processor to implement the method as described in the above embodiments.

Any ordinary skilled person in the art may understand that a computer program may instruct relevant hardware to perform all or part of the processes in the methods of the above embodiments. The program may be stored in the non-transitory computer-readable storage medium, and that the program, when being executed, may include processes such as those described in the embodiments of the above-described methods. The storage medium may be a disk, a CD-ROM, the ROM, and so on.

Any reference to the memory, the storage, database, or any other medium as used herein may include a non-volatile and/or volatile memory. A proper non-volatile memory may include the ROM, a programmable ROM (PROM), an erasable PROM (EPROM), an electrically erasable PROM (EEPROM), or a flash memory. The volatile memory may include the random access memory (RAM), which is used as an external cache memory. As illustration and not limitation, the RAM may be configured in various forms, such as a static RAM (SRAM), a dynamic RAM (DRAM), a synchronous DRAM (SDRAM), a double data rate SDRAM (DDR SDRAM), and an enhanced synchronous DRAM (ESDRAM), a synchlink DRAM (SLDRAM), a rambus DRAM (RDRAM) and a direct rambus DRAM (DRDRAM).

It should be understood that references to “one embodiment” or “an embodiment” throughout the specification imply that a particular feature, structure, or characteristic in an embodiment is included in at least one embodiment of the present disclosure. Therefore, “in an embodiment” or “in one embodiment” at various sections throughout the specification may not necessarily refer to a same embodiment. Furthermore, the particular feature, structure or characteristics may be combined in one or more embodiments in any suitable manner. Any ordinary skilled person in the art shall also be aware that the embodiments described in the specification are optional embodiments, and actions and modules involved are not necessary for the present disclosure.

In various embodiments of the present disclosure, it is understood that magnitudes of serial numbers of the above processes do not imply a necessary sequence or order of execution, and the order of execution of the processes should be determined by functions and inherent logic. Therefore, the serial numbers do not limit implementation of the embodiments of the present disclosure.

Units illustrated above as separated components may or may not be physically separated from each other, and the components shown as units may or may not be physical units, i.e., the components may be located in one place or may be distributed to a plurality of network units. Some or all of these units may be selected to fulfill the purpose of the embodiments according to actual needs.

In addition, each functional unit in the embodiments of the present disclosure may be integrated in one processing unit, or various units may physically exist separately from each other, or two or more units may be integrated in one unit. The integrated units may be configured as either in the form of hardware or in the form of software functional units.

The above integrated units may be stored in a computer-accessible memory when being configured in the form of the software functional units and sold or used as an independent product. Based on this understanding, the technical solution of the present disclosure in essence or a part that contributes to the related art or all or part of the technical solution may be embodied in the form of a software product. The software product is stored in a memory including a number of requests for causing a computer device (which may be a personal computer, a server, or a network device, and so on, and in particular, a processor in the computer device) to execute part or all of the blocks of the method described in the above various embodiments of the present disclosure.

The interface displaying method, the apparatus, the terminal device and the computer-readable storage medium in the embodiments of the present disclosure are described in detail in the above. Specific examples are described herein to illustrate principles and implementation of the present disclosure, and the above illustrations of embodiments are only used to assist in understanding the method of the present disclosure and core concepts of the present disclosure. At the same time, any ordinary skilled person in the art may perform, based on the concept of the present disclosure, changes in specific implementations and the application scope. In summary, the contents of the specification shall not be interpreted as a limitation of the present disclosure.

1. An interface displaying method, comprising:
determining a current operation state of a terminal device, wherein the operation state comprises any one of: a first state in which a first operating system is constantly running in a foreground, a second state in which only a second operating system is running, and a third state in which the terminal device is operating by switching between the first operating system and the second operating system; and
drawing an interface based on a displaying effect corresponding to the current operation state and displaying the drawn interface.

2. The interface displaying method according to claim 1, wherein, the operating power consumption of the first operating system is higher than the operating power consumption of the second operating system; and the drawing an interface based on a displaying effect corresponding to the current operation state and displaying the drawn interface, comprises:
when the terminal device is running the first operating system, drawing, by the first operating system, a dynamic interface with a dynamic displaying effect and displaying the dynamic interface in response to the current operation state being the first state;
drawing, by the first operating system, a dynamic-static mixing interface or a static interface with a static displaying effect and displaying the dynamic-static mixing interface or the static interface in response to the current operation state being the third state,
wherein the dynamic-static mixing interface is an interface having both a dynamic image and a static image.

3. The interface displaying method according to claim 2, wherein the drawing, by the first operating system, a dynamic interface with a dynamic displaying effect and displaying the dynamic interface, comprises:
drawing, by the first operating system, each displaying frame sequentially according to interface data of the dynamic interface; taking the drawn displaying frame to refresh a screen to form the dynamic interface having the dynamic displaying effect; wherein a refreshing frame rate of the dynamic interface is determined according to a current remaining power level of the terminal device.

4. The interface displaying method according to claim 2, wherein a dynamic effect of the dynamic-static mixing interface is less than a dynamic effect of the dynamic interface.

5. The interface displaying method according to claim 2, wherein before the determining a current operation state of a terminal device, the method further comprises:
when the terminal device is running the first operating system, obtaining a dynamic effect activation parameter in response to the first operating system receiving an interface loading request, wherein the dynamic effect activation parameter is configured to indicate whether or not the dynamic displaying effect is activated; and
the determining a current operation state of a terminal device, comprises:
determining, by the first operating system, the current operation state of the terminal device based on the dynamic effect activation parameter.

6. The interface displaying method according to claim 5, wherein the determining, by the first operating system, the current operation state of the terminal device based on the dynamic effect activation parameter, comprises:
determining, by the first operating system, that the current operation state of the terminal device is the first state in response to the dynamic effect activation parameter indicating that the dynamic displaying effect is activated; and
determining, by the first operating system, that the current operation state of the terminal device is the third state in response to the dynamic effect activation parameter indicating that the dynamic displaying effect is deactivated.

7. The interface displaying method according to claim 5, further comprising:
updating the dynamic effect activation parameter in response to detecting a turn-on operation or a turn-off operation performed on a dynamic effect switch, wherein the turn-on operation and the turn-off operation correspond to different dynamic effect activation parameters.

8. The interface displaying method according to claim 2, wherein the drawing, by the first operating system, a dynamic-static mixing interface, comprises:
drawing, by the first operating system, a static background image and drawing information displaying pattern with the dynamic displaying effect on the static background image, wherein richness of dynamic changes corresponding to the information displaying pattern is in a negative correlation with a remaining power level of the terminal device.

9. The interface displaying method according to claim 8, wherein the richness of dynamic changes comprises: a frequency at which the information displaying pattern of the dynamic-static mixing interface is re-drawn and displayed; and/or the number of information displaying patterns which are in the dynamic-static mixing interface and have dynamic changes.

10. The interface displaying method according to claim 1, wherein the operating power consumption of the second operating system is less than the operating power consumption of the first operating system; and the drawing an interface based on a displaying effect corresponding to the current operation state and displaying the drawn interface, comprises:
when the terminal device is running the second operating system, drawing, by the second operating system, a static interface having a static displaying effect and displaying the static interface in response to the current operation state being the second state or the third state.

11. The interface displaying method according to claim 1, wherein the determining a current operation state of a terminal device, comprises:
when the terminal device is in a first operating mode, determining that the current operation state of the terminal device is the first state in response to detecting a turn-on operation performed on a dynamic effect switch;
when the terminal device is in the first operating mode, determining that the current operation state of the terminal device is the third state in response to detecting a turn-off operation performed on the dynamic effect switch;
when the terminal device is in a second operating mode, determining that the current operation state of the terminal device is the second state; and
wherein the first operating mode is an operating mode in which the terminal device switches between the first operating system and the second operating system, and the second operating mode is an operating mode in which the terminal device runs only the second operating system.

12. The interface displaying method according to claim 1, further comprising:
when the current operation state is the third state and the terminal device is running the first operating system, switching to the second operating system in response to a first switching condition being satisfied; and when the terminal device is running the second operating system, switching to the first operating system in response to a second switching condition being satisfied; wherein the first switching condition is different from the second switching condition.

13. The interface displaying method according to claim 12, wherein the first switching condition comprises one or more of: the terminal device staying in a screen-off state for a first time length, a remaining power level of the terminal device being lower than a power threshold, and detecting a switching operation of switching from the first operating system to the second operating system; and
the second switching condition comprises one or more of: receiving a trigger operation that triggers entry a target application, receiving a displaying request for displaying a list of applications, and detecting a switching operation of switching from the second operating system to the first operating system.

14-18. (canceled)

19. A terminal device, comprising: a memory and a processor, wherein the memory stores a computer program therein, the computer program is configured to cause, when being executed by the processor, the processor to implement operations of:
determining a current operation state of a terminal device, wherein the operation state comprises any one of: a first state in which a first operating system is constantly running in a foreground, a second state in which only a second operating system is running, and a third state in which the terminal device is operating by switching between the first operating system and the second operating system; and
drawing an interface based on a displaying effect corresponding to the current operation state and displaying the drawn interface.

20. A computer-readable storage medium, storing a computer program, wherein the computer program is configured to cause, when being executed by a processor, the processor to implement operations of:
determining a current operation state of a terminal device, wherein the operation state comprises any one of: a first state in which a first operating system is constantly running in a foreground, a second state in which only a second operating system is running, and a third state in which the terminal device is operating by switching between the first operating system and the second operating system; and
drawing an interface based on a displaying effect corresponding to the current operation state and displaying the drawn interface.

21. The terminal device according to claim 19, wherein, the operating power consumption of the first operating system is higher than the operating power consumption of the second operating system; and the drawing an interface based on a displaying effect corresponding to the current operation state and displaying the drawn interface, comprises:
when the terminal device is running the first operating system, drawing, by the first operating system, a dynamic interface with a dynamic displaying effect and displaying the dynamic interface in response to the current operation state being the first state;
drawing, by the first operating system, a dynamic-static mixing interface or a static interface with a static displaying effect and displaying the dynamic-static mixing interface or the static interface in response to the current operation state being the third state,
wherein the dynamic-static mixing interface is an interface having both a dynamic image and a static image.

22. The terminal device according to claim 21, wherein the drawing, by the first operating system, a dynamic interface with a dynamic displaying effect and displaying the dynamic interface, comprises:
drawing, by the first operating system, each displaying frame sequentially according to interface data of the dynamic interface; taking the drawn displaying frame to refresh a screen to form the dynamic interface having the dynamic displaying effect; wherein a refreshing frame rate of the dynamic interface is determined according to a current remaining power level of the terminal device.

23. The terminal device according to claim 19, wherein a dynamic effect of the dynamic-static mixing interface is less than a dynamic effect of the dynamic interface.

24. The terminal device according to claim 19, wherein before the determining a current operation state of a terminal device, the method further comprises:
when the terminal device is running the first operating system, obtaining a dynamic effect activation parameter in response to the first operating system receiving an interface loading request, wherein the dynamic effect activation parameter is configured to indicate whether or not the dynamic displaying effect is activated; and
the determining a current operation state of a terminal device, comprises:
determining, by the first operating system, the current operation state of the terminal device based on the dynamic effect activation parameter.

25. The terminal device according to claim 24, wherein the determining, by the first operating system, the current operation state of the terminal device based on the dynamic effect activation parameter, comprises:
determining, by the first operating system, that the current operation state of the terminal device is the first state in response to the dynamic effect activation parameter indicating that the dynamic displaying effect is activated; and
determining, by the first operating system, that the current operation state of the terminal device is the third state in response to the dynamic effect activation parameter indicating that the dynamic displaying effect is deactivated.
